(19) United States
(12) Patent Application Publication
(10) Pub. No.: US 2005/0081008 A1
(43) Pub. Date: Apr. 14, 2005

(54) Loading of media

(76) Inventors: Stephen Gold, Fort Collins, CO (US); Robert Gibson, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/684,207

(22) Filed: Oct. 10, 2003

(51) Int. Cl. G06F 12/16

(52) U.S. Cl. 711/162

(57) ABSTRACT

In one embodiment, a method is disclosed that comprises receiving a list of media to be loaded into a plurality of backup devices, ordering the list by physical location of the backup devices, and presenting the ordered list to a user.

### BACKGROUND OF THE INVENTION

Backup applications use scratch media to process backup jobs that backup data. Scratch media are either new media or media that contain data that can be overwritten. In order for the backup jobs to execute properly, scratch media of the appropriate type must be loaded into the backup devices, such as tape libraries, used by the backup applications.

After determining the amount and type of media to be loaded into each of the backup devices, one or more operators must physically load media. With large configurations, media may need to be loaded into devices spread across large data centers and possibly distributed into multiple data centers within a site. When loading media, operators have limited alternatives. Fore example, operators may have to choose between randomly moving among devices in single and multiple data centers or searching a list to find the media to be loaded into a device and then searching through a pile of media to find the media on the list. Either choice may result in the use of a highly inefficient process to load the media.

### SUMMARY OF THE INVENTION

In one embodiment, a method is disclosed that comprises receiving a list of media to be loaded into a plurality of backup devices. The list is ordered by physical location of the backup devices and the ordered list is presented to a user.

### BRIEF DESCRIPTION OF THE DRAWINGS

Illustrative embodiments in accordance with the invention are illustrated in the drawings in which:

FIG. 1 illustrates an exemplary configuration of a media manager to optimize the loading of scratch media for one or more backup devices;

FIG. 2 is a flow diagram illustrating an exemplary method for optimizing the loading of scratch media that may be used by the media manager of FIG. 1;

FIG. 3 is a flow diagram illustrating an exemplary method for configuring physical locations of devices that may be used by the media manager of FIG. 1;

FIG. 4 illustrates an exemplary presentation to a user of an ordered list of media to be loaded into the backup devices;

FIG. 5 is a flow diagram illustrating an exemplary method that may be used by the media manger of FIG. 1 to manage scratch media to be loaded into the backup devices;

FIG. 6 illustrates an exemplary user interface that may be used by a user to enter media to be used for the required scratch media; and

FIG. 7 is a flow diagram illustrating an exemplary method for calculating required scratch media that may be used by the method of FIG. 5.

### DETAILED DESCRIPTION

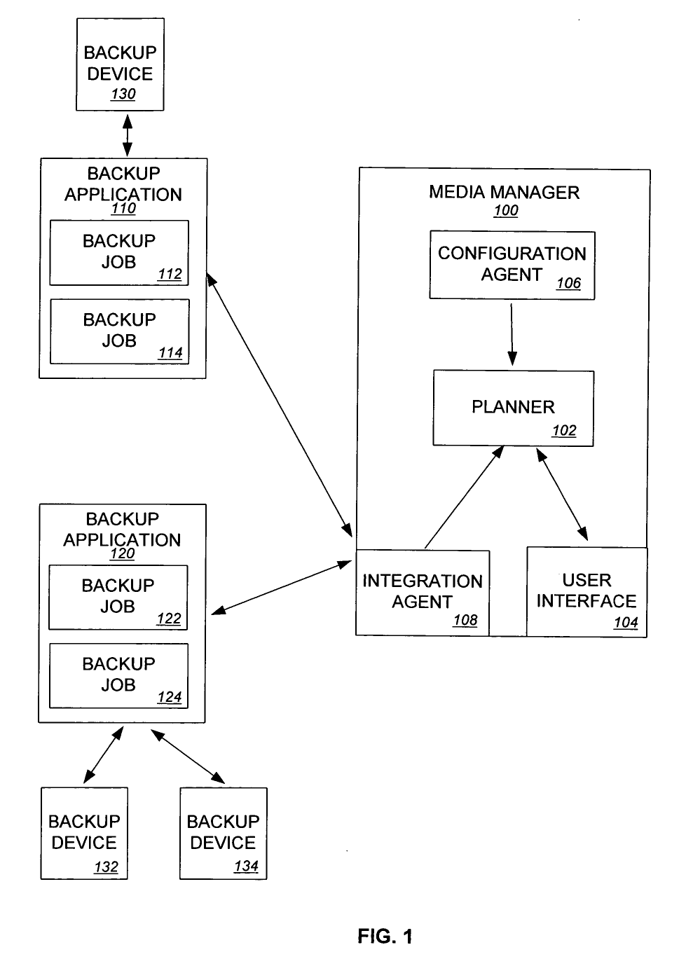

An exemplary configuration using a media manager to optimize the loading of media is illustrated in FIG. 1. It should be understood that that the term media should not be regarded as being limited to two or more pieces of media, but could also include a single medium. The media manager 100 may be responsible for optimizing the loading of media for multiple backup devices 132, 134, 136. By way of example, backup devices may be tape libraries, optical tape libraries, or standalone tape drives. Other backup devices may also be used.

In one embodiment, the media to be loaded may be used as scratch media for multiple backup applications 110, 120. Scratch media are either new media or media that contain data that can be overwritten. Backup application 110 is responsible for backup jobs 112, 114 and uses backup device 130 to backup and restore data. Similarly, backup application 120 is responsible for backup jobs 122, 124 and uses backup device 132,134 to backup and restore data. The backup jobs 112, 114, 122, 124 may each be full or incremental backups of data contained in various locations, such as on backup server(s) executing the backup applications 110, 120, one or more clients communicatively coupled to the backup servers, or other location (e.g., disk device) storing data to be backed up. It should be appreciated that in alternate embodiments, each backup application 110, 120 may be responsible for a larger number of backup jobs than that illustrated in FIG. 1 and may each use a different number of backup devices to store and retrieve data.

Media manager 100 may include a planner 102 to receive a list of media to be loaded into the backup devices 130, 132, 134 and to order the list by physical location of the backup devices. The physical location of the backup devices may be configured by configuration agent 106. Configuration agent 106 may obtain this information from a user using user interface 104 or may import this information from another location. The configuration of the physical locations of the devices will be described in further detail below. It should be appreciated that configuration agent 106 may store the configuration information in a data location (such as a database) and the planner 102 may retrieve this information from the data location rather than directly from configuration agent 106. It should also be appreciated that in alternate embodiments, media manager 100 may not include configuration agent 106 and may instead use an alternate mechanism to order the list of media by physical location.

In one embodiment, planner 102 may receive the list of media to be entered into the backup devices 130, 132, 134 from a user using user interface 104. Media manager 100 may help the user determine how much media needs to be loaded by using planner 102 (or another component) to calculate a required number of scratch media needed by the backup applications 110, 120 for future executions of the backup jobs and presenting the required number to a user via user interface 104. This calculation may be based on backup job information obtained by integration agent 108 from backup applications 110, 120.

By way of example, backup applications 110, 120 may send the backup job information for their respective backup jobs via a communicative coupling (e.g., internet or intranet) between the backup applications 110, 120 and media manager 100 using an open communication, such as XML (Extensible Markup Language). The backup job information may include devices and/or media pools used by the backup jobs, scratch media currently available in each of the backup devices and/or media pools, types of media used, compression rates, types of the backup jobs (e.g., full or incremental), locations of the data being backed up by the backup jobs, historical backup size information for the backup jobs, future scheduled executions of the backup jobs, and any other information that may be used to estimate the required number of media needed for future executions of the backup jobs. The calculation of the required number of scratch media will be described in further detail below. It should be appreciated that in alternate embodiments, media manager 100 may not calculate the required number of scratch media for the user and thus may not include integration agent 108 and/or may not be communicatively coupled to backup applications 110, 120.

Media manager 100, planner 102, user interface 104, configuration agent 106, and integration agent 108 may be implemented in software, firmware, hardware, or a combination of these. Additionally, these components may reside on separate physical locations, such as separate servers. By way of example, user interface 106 may be a web browser on a remote client.

It should be appreciated that configurations different than the one shown in FIG. 1 may be used in alternate embodiments. For example, integration agent 108 may additionally or alternately reside one or more of the servers executing the backup applications managed by the media manager 100. This configuration may facilitate the exchange of information in configurations containing firewalls.

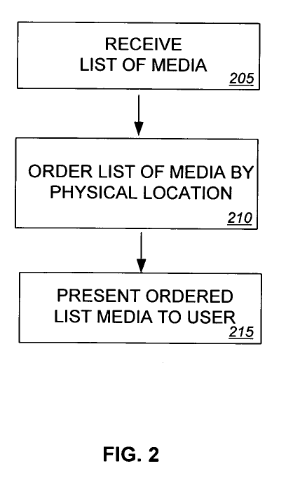

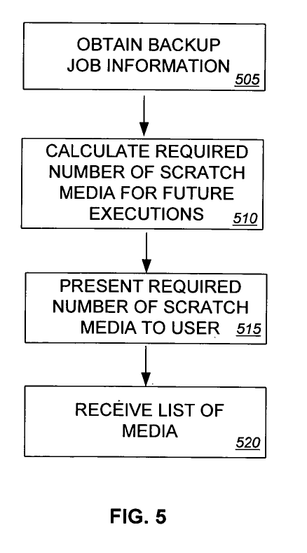

FIG. 2 illustrates an exemplary method of optimizing the loading of scratch media that may be used by media manager 100. A list of media to be loaded into a plurality of backup devices 130, 132, 134 is received 205. The media list may include an amount of media, the backup device in which to load the media, and the media pool from which the media is to be taken. By way of example, the list may have been received from a software process that calculates the scratch media requirements for the devices (as described in 505, 510 with reference to FIG. 5), from one or more backup applications, or from another location.

In one embodiment, the media list may also include media identifiers that may have been received from a user. For example, the list of media may have been received from a user in a process similar to that described below in reference to FIG. 5. Next, the list is ordered 210 by physical location of the backup devices. The ordered list is then presented 215 to a user.

In one embodiment, the list may be ordered using an order number associated with each of the backup devices. The order number may indicate the physical proximity of the devices to the first device an operator will load. By way of example, the first device the operator will load may have an order number of one. Devices may then be ordered sequentially by proximity to this first device. Configuration agent 106 may have obtained this information from the user using user interface 104. Alternately, configuration agent 106 may calculate an order number by using other configuration information entered by a user (e.g., grid location of devices).

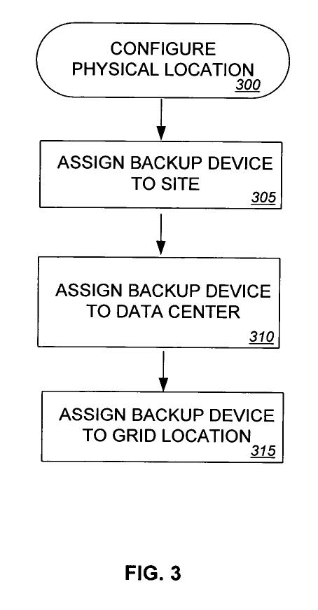

FIG. 3 illustrates a method of configuring 300 physical locations of the devices that can be used to order 210 the media to be loaded into the devices. This method may be used in addition to, or in place of, the order numbering described above. Information for one or more site locations may be obtained using configuration agent 106. Each of the backup devices may then be assigned 305 to one of the site locations. Each site may have different geographical locations and may each have their own ordered list created for loading media.

Each site may contain multiple data centers. Information for one or more data centers, each of which is associated with a site, may also be obtained using configuration agent 106. The backup devices may then be assigned 310 to a data center. The data centers may each be assigned a global order number based on physical proximity to each other. By way of example, the data center containing the devices which are to be loaded first may be assigned a global order number of one. Additional data centers in a site may then be assigned an order number based on their physical proximity to the first data center. Alternately, an ordered list of media may be created for each data center or subset of the data centers.

Information on grid locations within each of the data centers may also be configured using configuration agent 106. The grid locations may indicate a physical location in the data center. Backup devices may then be assigned 315 to a grid location. In one embodiment, backup devices may be automatically assigned the same grid location as the grid location associated with the system to which the backup device is attached. Grid locations may each be assigned an order number indicating the order in which devices located at the respective grid location are to be ordered. The order number may be based on a combination of data center and grid location or just the grid location.

The information and assignments used to configure the physical locations of the devices may be obtained from a user via user interface 104 or may be imported or retrieved from another location. In alternate embodiments, backup devices may be assigned to only one or a subset of site location, data center location, and grid location. Additionally, in some embodiments, backup devices may obtain a portion of the physical location configuration information by default. By way of example, a device may be assigned to a data center and by default obtain the assignment to the associated site.

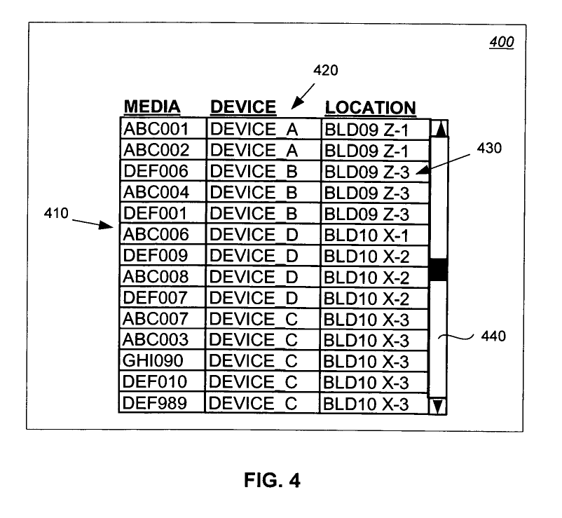

FIG. 4 illustrates an exemplary screen that may be used to present 215 the ordered list to a user. An ordered list may be presented for each site location, each data center location, or a subset of data center locations. The user interface 104 may present the information to a user on a screen 400 containing a column 410 with an ordered list of media. As previously described, the list may be ordered by physical location of the backup devices.

A second column 420 contains the device in which the media is to be loaded. The physical location of the device may be presented in a third column 430. In one embodiment, the physical location presented to the user may include a combination of data center and grid location. As the media list may be lengthy, scroll bar 440 may also be provided for the user to scroll through the list. The user may print the ordered list and use the list to optimize the loading of the media into the devices. In alternate embodiments, the ordered list may be presented to a user in a different manner than that illustrated in FIG. 4.

FIG. 5 illustrates an exemplary method that may be used to assist the user in determining how much media needs to be loaded into the backup devices 130, 132, 134 to meet the scratch media needs for future executions of backup jobs 112, 114, 122, 124. Backup job information is obtained 505 from one or more backup applications 110, 120 for a plurality of backup jobs 112, 114, 122, 124. As previously described, backup job information may include backup devices and/or media pools used by the backup jobs, scratch media available in each of the devices and/or media pools, types of media used, compression rates, types of the backup jobs (e.g., full or incremental), locations of the data being backed up by the backup jobs, historical backup size information for the backup jobs, future scheduled executions of the backup jobs, and other information that may be used to estimate a required number of scratch media needed for future executions of the backup jobs.

Next, the required number of scratch media needed for one or more future executions of at least one of the backup jobs is calculated 510 using the backup job information. Planner 102 may estimate the required number of scratch media required for the future executions of backup jobs scheduled within a predetermined period of time. The calculation may be performed in any manner that estimates the number of scratch media that will be required for future executions of one or more of the backup jobs.

In one embodiment, a user may divide the backup jobs into one or more subsets and may configure media manager 100 to perform the calculation 510 for one or more of these subsets at different intervals of time. By way of example, a user may configure media manager 100 to perform the calculation for subset A of the backup jobs on a daily basis and to perform the calculation for subset B of the backup jobs on Tuesdays and Thursdays. Backup jobs may be divided into subsets according to data center, importance of data being backed up, or other criteria determined by the user. The number of scratch media that the backup jobs in a subset is estimated to require may be calculated 510 for the time period before the next calculation for that subset is scheduled to be performed. The calculated required number of scratch media is then presented 515 to a user.

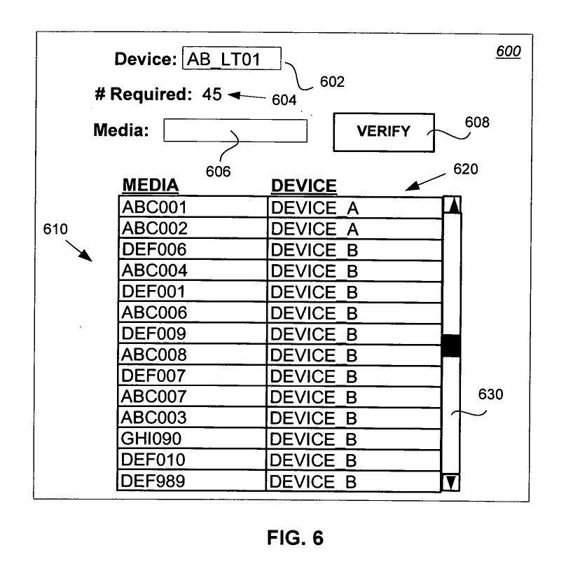

After presenting the required number of scratch media to a user 515, media manager 100 may receive 520 a list from the user of one or more media to be used for at least a portion of the required scratch media. FIG. 6 illustrates an exemplary screen 600 that may be provided by user interface 104 for the user to enter a list of one or more media to be used for the required scratch media.

A text-entry area 602 is provided for the user to enter a device for which the media is to be entered. In alternate embodiments, the media may be entered for specific media pools contained within a backup device and the user interface 104 may provide a text entry area for the media pool in which the media is to be entered or may provide areas for the user to enter media for a combination of backup device and media pool. A display area 604 displays the number of media required for the device. In alternate embodiments, screen 600 may not include display area 604 or may include additional or alternate display areas to display the number of media required for a selected media pool.

Screen 600 further includes a text entry area 606 to enter the media to be used for the scratch media for the device and/or media pool. The user interface 104 may receive this information, for example, from a keyboard or a barcode scanner used to scan barcodes located on the media. After the media is entered, a verify button 608 is provided for the planner 102 determine if the media are valid scratch media. Alternately, the user may be prompted to verify or skip verification as each piece of media is entered.

In order to determine if the media are valid scratch media, various factors may be taken into account. One factor that may be used is whether a protection date has expired for a previously written data media. Other factors such as the quality of the media (which may be determined from backup job information based on previous problems encountered by backup applications 110, 120 in using the media) or whether the media is included or initialized in the appropriate media pool may also be used to determine if the media may be used to meet the scratch media requirements for the future executions of one or more backup jobs. In alternate embodiments, the planner may not determine if the media are valid scratch media and the screen 600 may not include verify button 608.

Screen 600 further includes a column 610 listing the media entered by the user. The device for which the media is to be entered is listed in a second column 620. As the media list may be lengthy, scroll bar 630 may also be provided for the user to scroll through the list. In alternate embodiments, the second column 620 may display the media pool for which the media is to be entered or an additional column may be provided to display this information.

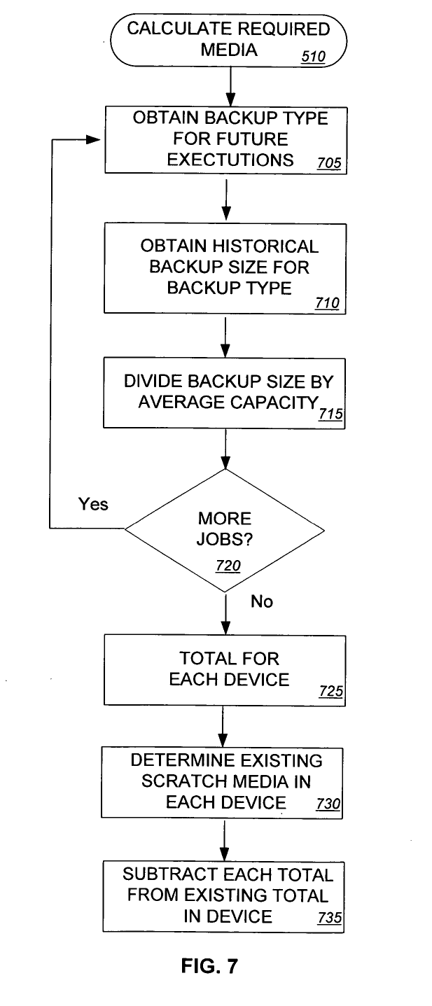

FIG. 7 illustrates an exemplary method that may be used to calculate 510 the required number of scratch media needed for one or more future executions of at least one backup job. The method begins by obtaining 705, for a future execution of a backup job, the type of the backup job to be performed. By way of example, the backup type may be a full or incremental backup. In alternate embodiments, the backup type may not need to be obtained 705 as each backup job may be associated with a predetermined type of backup.

Next, an average historical backup size for the type of backup to be executed is obtained 710. The average historical size may be calculated by planner 102 by averaging backup sizes for previous executions of the backup job. Alternately, the average historical backup size may be included in the backup job information obtained from the backup application responsible for the backup job.

The number of media required for the future execution is then estimated at 715 by dividing the average historical backup size by the average capacity of the media type used by the backup job. In some embodiments (e.g., embodiments in which the media is defined as non-appendable), the required number of media may be rounded to the next or nearest whole number. In other embodiments (e.g., where the media may be appended), the required number of media may be rounded after totaling the number of media required for all backup jobs and subtracting from an available existing capacity (e.g., at 535). If the average backup size is not available, either because the backup job has not previously executed or other reason, a default number of scratch media, that may be based on the type of backup device and/or the type of backup job, may be used to estimate the required number of scratch media needed for the future execution of the backup job. Planner 102 may calculate the average capacity of the media type by obtaining, from the backup job information, the type of media used for the backup job and any compression information for the backup job or media pool used by the backup job. Alternately, the backup job information may include the average capacity of the media type used by the backup job.

If there are more future executions of additional backup jobs 720 which are included in the calculation 510, the method continues back at 705 to obtain the backup type for another future execution. It should be appreciated that if the calculation 510 includes multiple future executions of the same type of the same backup job, the number of media may be calculated for those executions by multiplying the number of executions by the amount obtained from 715.

If there are no more future executions of backup jobs to process 720, the method may continue by totaling 725 the number of media required for each device. The existing number of scratch media that will be available in each device is also determined 730. The existing number of scratch media available in each device may be determined from information included in the backup job information.

Additional factors may also be taken into account when determining the existing number of scratch media. By way of example, a determination may be made if a protected period for one or more existing data media in the device have expired, which may mean the data media may be overwritten and used as scratch media. A second factor that may be taken into account is the availability of appendable media (media that contains data that may be appended by a future execution of a backup job). The number of media required for each device may be totaled 725 for both non-appendable media (for backup jobs that may not append to existing media) and appendable media (for backup job that may append to existing media).

In one embodiment, the scratch media may be distributed into one or more media pools, each media pool associated with one or more of the backup jobs. Each of the media pools may contain media located in one backup device or multiple interconnected backup devices (e.g., interconnected tape libraries). The backup jobs may only use scratch media contained in their associated media pools. In this embodiment, a total may be calculated for each media pool, instead of, or in addition to a total 725 for each device. Similarly, the existing number of scratch media may be determined for each media pool instead of, or in addition to, determining 730 the existing number of scratch media available in a device.

For each device and/or media pool, the total number required is subtracted 735 from the existing number of scratch media contained in the device or media pool. In embodiments using appendable media, the existing capacity may also be subtracted from the total capacity required for appendable media. The remaining required capacity may then be divided by an average capacity of the media type to obtain a required number of appendable media. This total may then be combined with the estimated required total number of non-appendable media. It should be appreciated that in alternate embodiments the order of the method depicted in FIG. 7 may be changed. For example, the determination of the number of existing scratch media 730 may be made prior to calculating the total media required for each device 725.

The methods described above may be performed by hardware components or may be embodied in sequences of machine-executable instructions, which may be used to cause a machine, such as a general-purpose or special-purpose processor or logic circuits programmed with the instructions to perform the actions set forth in FIGS. 2, 3, 5, and 7. Alternatively, the methods may be performed by a combination of hardware and software.

1. A method comprising:
receiving a list of media to be loaded into a plurality of backup devices;
ordering the list by physical location of the backup devices; and
presenting the ordered list to a user.

2. The method of claim 1, further comprising before receiving the list of media, configuring a physical location for each of the backup devices.

3. The method of claim 2, wherein configuring the physical location comprises obtaining information for one or more site locations and assigning each of the backup devices to one of the site locations.

4. The method of claim 3, wherein configuring the physical location further comprises:
obtaining information for one or more data centers, each of the data centers associated with one of the site locations; and
assigning each of the backup devices to one of the data centers.

5. The method of claim 2, wherein configuring the physical location comprises assigning a grid location in a data center to at least one of the backup devices.

6. The method of claim 5, wherein configuring the physical location further comprises assigning an order number to each of the grid locations.

7. The method of claim 5, wherein assigning a grid location comprises for at least one of the backup devices, automatically assigning, to the backup device, a grid location of a system attached to the backup device.

8. The method of claim 1, wherein ordering the list comprises ordering the list of media by an order number associated with each of the backup devices.

9. The method of claim 1, wherein receiving the list of media comprises:
receiving a list of media from a user to be used for one or more future executions of one or more backup jobs associated with the backup devices.

10. The method of claim 9, further comprising, before receiving the list of media, calculating a required number of scratch media needed for the future executions and presenting the required number of scratch media to the user.

11. The method of claim 10, wherein calculating comprises:
obtaining backup job information from one or more backup applications for the backup jobs; and
using the backup job information to calculate the required number of scratch media needed for the future executions.

12. The method of claim 10, wherein calculating the required number of scratch media comprises for at least one of the future executions, dividing an average historical backup size of the backup job by an average capacity of a media type associated with the backup job.

13. A system comprising:
a planner to receive a list of media to be loaded into a plurality of backup devices and to order the list by physical location of the backup devices; and
a user interface, communicatively coupled to the planner, to present the ordered list to a user.

14. The system of claim 13, further comprising a configuration agent, communicatively coupled to said planner, to configure a physical location for each of the backup devices.

15. The system of claim 13, wherein said user interface is further to receive a list of media to be used for one or more future executions of one or more backup jobs associated with the backup device and to transmit the list to said planner.

16. The system of claim 15, wherein said planner is further to calculate a required number of scratch media needed for the future executions; and
wherein said user interface is further to present the required number of scratch media to a user.

17. The system of claim 16, further comprising an integration agent, communicatively coupled to said planner, to receive backup job information from one or more backup applications and wherein said planner uses the backup job information to calculate the required number of scratch media.

18. The system of claim 17, wherein the backup job information includes an average historical backup size for one or more of the backup jobs and said planner uses the average historical backup size to calculate the required number of scratch media.

19. At least one machine-readable medium having stored thereon sequences of instructions, which, when executed by a machine, cause the machine to perform the actions of:
receiving a list of media to be loaded into a plurality of backup devices;
ordering the list by physical location of the backup devices; and
presenting the ordered list to a user.

20. The medium of claim 19, wherein the instructions for presenting the required number of scratch media comprise instructions, which, when executed by the machine, cause the machine to perform the actions of before receiving the list of media, configuring a physical location for each of the backup devices.

21. The medium of claim 20, wherein the instructions for configuring the physical location comprise instructions, which, when executed by the machine, cause the machine to perform the actions of assigning a grid location in a data center to at least one of the backup devices.

22. The medium of claim 20, wherein the instructions for configuring the physical location comprise instructions, which, when executed by the machine, cause the machine to perform the actions of assigning an order number to each of the grid locations.

23. The medium of claim 19, further comprising instructions which, when executed by the machine, cause the machine to perform the actions of:
before receiving the list of media, calculating a required number of scratch media needed for one or more future executions of one or more backup jobs associated with the backup devices;
presenting the required number of scratch media to the user; and
wherein receiving the list of media comprises receiving a list of media from a user to be used for the future executions.
